(19) United States
(12) Patent Application Publication
(10) Pub. No.: US 2014/0215788 A1
(43) Pub. Date: Aug. 7, 2014

(54) Method for assembling a crusher

(71) Applicant: FLSmidth A/S, Valby (DK)

(72) Inventors: Matt Ford, Sandy, UT (US); Stephen Harris, Emmaus, PA (US); Dale Kaskisto, Virginia, MN (US)

(73) Assignee: FLSmidth A/S, Valby (DK)

(21) Appl. No.: 14/087,580

(22) Filed: Nov. 22, 2013

(30) Foreign Application Priority Data
Dec. 4, 2012 (DK) PA 2012 70754

(51) Int. Cl. B23P 11/00

(52) U.S. Cl. CPC B23P 11/00
USPC 29/407.1

(57) ABSTRACT

Described is a method for assembling a gyratory crusher (1) where a main shaft arrangement (2) having a main shaft (3) with a midmost axial portion enclosed by a first crushing surface (4) is lowered axially from a free-hanging position down into a centrally positioned bushing (5) which provides guidance and support for the main shaft (3) where at least a portion of the bushing (5) is located below the first crushing surface (4) which is configured for interaction with an opposite second crushing surface (6). The method is characterized in that the method comprises the steps of mounting guiding means (7) on the main shaft arrangement (2) prior to guiding the main shaft (3) into the bushing (5) where the guiding means (7) protrude radially in relation to the centre axis of the main shaft (3) to such an extent that the guiding means (7) are visible when viewed from an axial top position over the main shaft arrangement (2), and having an operator with a view from the axial top position to lower the main shaft (3) down into the bushing (5) while observing the relationship between the second wear surface (6) and the guiding means (7).

The present invention relates to crushers, particularly gyratory crushers. More precisely, the invention relates to a method for assembling a gyratory crusher where a main shaft arrangement having a main shaft with a central axial portion enclosed by a first crushing surface is lowered axially from a free-hanging position into a centrally positioned bushing which provides guidance and support for the main shaft, where at least a portion of the bushing is located below the first crushing surface which is configured for interaction with an opposite second crushing surface.

Gyratory crushers of this kind are well-known in the patent literature, for example from WO97/15395. A gyratory crusher typically comprises a frame provided with an outer crushing surface. An inner crushing surface is fitted by means of a crushing head on a main shaft to form a main shaft assembly. The main shaft is arranged to move in such a way that the inner crushing surface is in a kind of orbiting-pendulum motion with respect to the outer crushing surface. The movement of the main shaft is typically produced by means of an eccentric bushing which is rotated by means of a suitable transmission mechanism. The main shaft is placed in and supported by the eccentric bushing and during the rotation the position of the main shaft with respect to the frame of the crusher is changed. In other words, the distance between the different points of the outer and inner crushing surfaces varies during the rotation of the eccentric bushing. In a gyratory crusher, the movement of the main shaft is greater in the lower part than in the upper part. This is because the axial line of the main shaft and the rotation axis line of the eccentric bushing are not parallel, but the lines intersect at a so-called pivot point which typically is located above the crushing surfaces. The main shaft assembly must periodically, typically several times each year, be removed from the gyratory crusher for maintenance purposes. The present method for removing the main shaft assembly is an operation which does not involve risk of personal injuries for the operators when performed in accordance with the specified procedures. However, installing the main shaft assembly back into the gyratory crusher involves a significant risk of injuries since the operator has to work underneath an overhead suspended main shaft assembly which can weigh up to 100 tons. During the installation the operators must guide the main shaft manually into the eccentric bushing. In some gyratory crushers the operators also have to manually guide a seal located on the main shaft into a sealing sleeve bore while working underneath the main shaft assembly. Any failure of the lifting equipment, the crane, cable or lifting hook or erroneous crane operation will entail risk of serious or fatal injury to the operator.

It is an object of the present invention to provide a method for installing a main shaft arrangement in a gyratory crusher by means of which the assembly can be carried out in a way which does not involve risk for the operators involved.

This is obtained by a method of the kind mentioned in the introduction, and being characterized in that the method comprises the steps of:
mounting guiding means on the main shaft arrangement prior to guiding the main shaft into the bushing where the guiding means protrude radially in relation to the centre axis of the main shaft to such an extent that the guiding means are visible when viewed from an axial top position over the main shaft arrangement, and
having an operator with a view from the axial top position to lower the main shaft down into the bushing while observing the relationship between the second wear surface and the guiding means.

Hereby it is obtained that the need for operators to be present underneath the main shaft arrangement during installation is avoided. This means elimination of the risk of serious or fatal injury posed by the main shaft assembly if the lifting equipment should fail or due to erroneous crane operation.

The bushing into which the main shaft is arranged is preferably an eccentric bushing which provides the gyratory movement of the crusher.

The guiding means may in principle be made from all kind of materials and have all kind of forms and sizes and may be distributed in various numbers and patterns around the main shaft arrangement as long as they protrude radially in relation to the centre axis of the main shaft and are visible when viewed from the axial top position over the main shaft arrangement so that the operator with a view from there will be able to lower the main shaft into the bushing while observing the guiding means. However, it is preferred that the guiding means are flexible and comprising at least four substantially flat and bendable guides being arranged circularly around the main shaft arrangement with equal angles between each of them. Furthermore, it is preferred that the guiding means are adjustable in the radial direction to suit the different needs of the operators and to suit different sizes of gyratory crushers. By having adjustable guiding means it will also be possible to compensate for wear in the crushing chamber and for an off centered eccentric bushing. The guiding means may be provided with new crushers or may be provided as retrofit kits since it is quite easy to fit such guiding means to existing main shaft arrangements.

It is preferred that the guiding means are dismounted and removed after the main shaft is guided into and supported by the bushing. Otherwise the guiding means will be damaged during operation unless designed to cope with the impacts occurring in the crusher; however, this will be unpractical and costly.

In one embodiment a radial sealing member provided at a central portion of the main shaft during the lowering of the main shaft arrangement is guided into a centrally positioned sleeve in the gyratory crusher by means of a sealing guiding device which is releasably attached to the sleeve and where the sealing guiding device is attached prior to the lowering of the main shaft arrangement. In gyratory crushers where the main shaft is provided with a radial sealing member, which is typically located under the first crushing surface, for providing a sealed connection between the main shaft and a sleeve for protection against dust, this sealing guide device eliminates the need for presence of personnel underneath the main shaft in order to guide it into the sleeve. Usually a portion of the main shaft is guided into the bushing before the radial sealing member is guided into the sleeve, thereby ensuring some prior support for the main shaft when the sealing member is guided into the sleeve. It is preferred that the released sealing guiding device is removed prior to the operation of the gyratory crusher.

In another embodiment an upper part of a sleeve, prior to lowering down the main shaft arrangement, is guided over the radial sealing member provided on the central portion of the main shaft and the upper part of the sleeve is connected to a bottom part of the sleeve which is attached to a frame in the gyratory crusher after the main shaft is placed in the bushing. Preferably, the upper part and the bottom part of the sleeve are connected by means of fastening means, such as bolt or screws.

The invention will now be explained in greater detail with reference to the drawings, being diagrammatical, and where

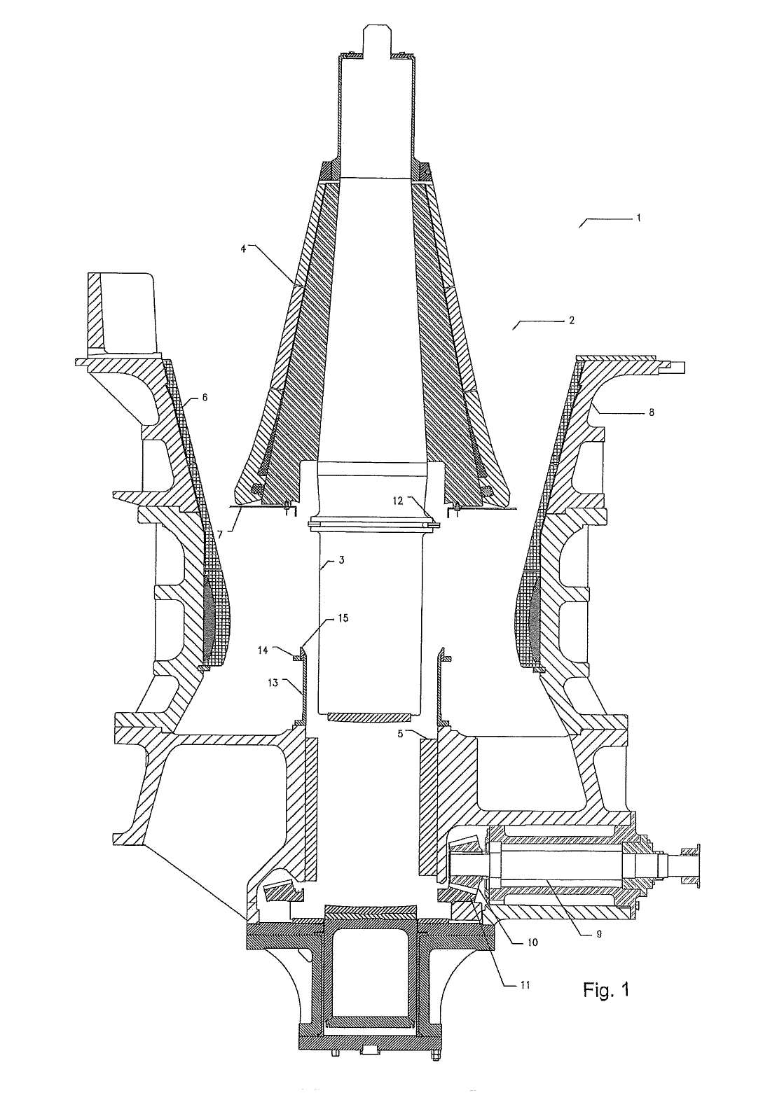

FIG. 1 shows a main shaft arrangement being installed in a gyratory crusher according to the invention,

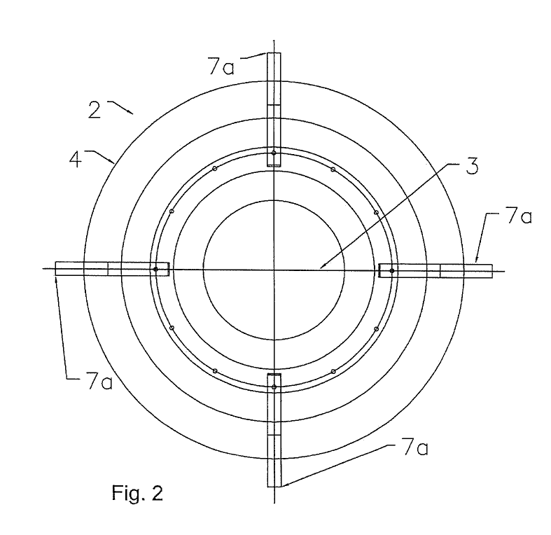

FIG. 2 shows a bottom view of a main shaft arrangement according to the invention,

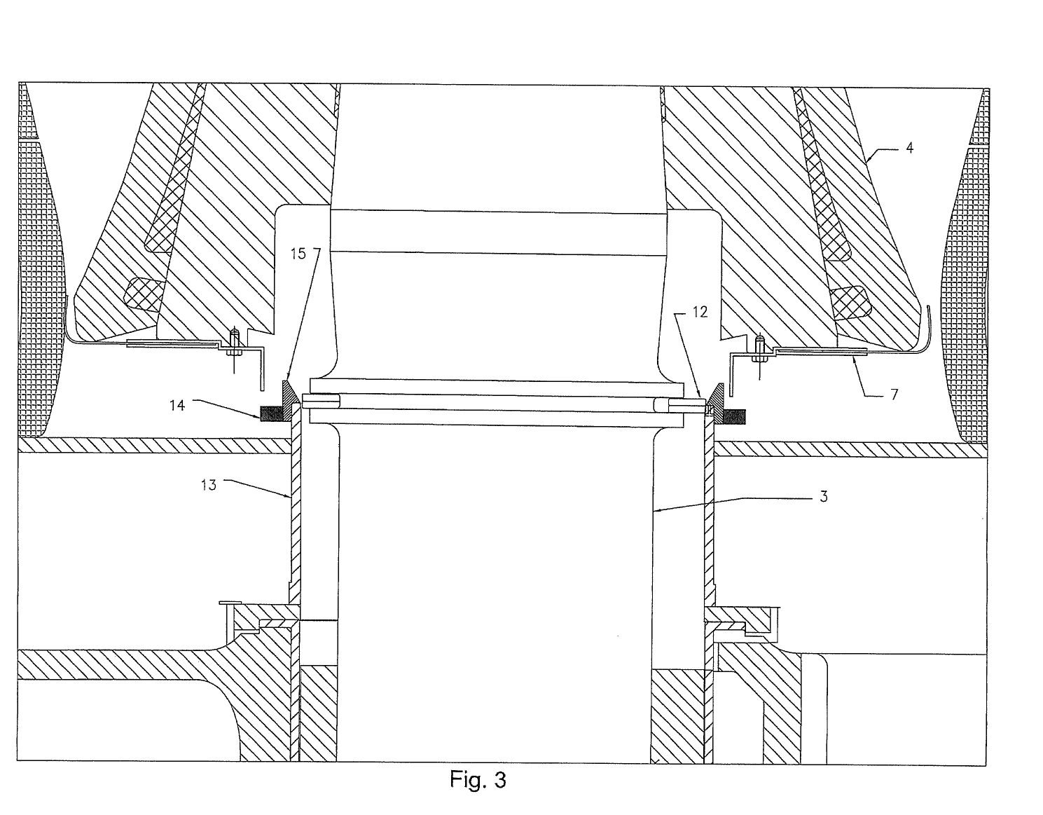

FIG. 3 shows an embodiment of a sealing guiding device according to the invention, and

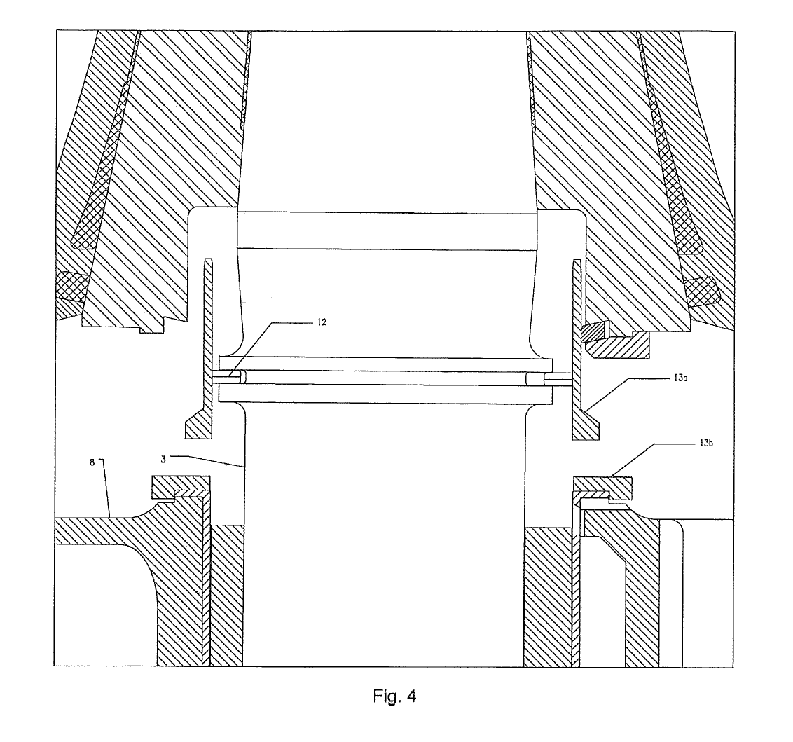

FIG. 4 shows an embodiment of a sleeve according to the invention.

In FIG. 1 is shown a gyratory crusher for crushing 1 bulk material, such as ore and rock materials, where a frame 8 is provided with a substantially concave second crushing surface 6. A substantially conical first crushing surface 4 is fitted on a main shaft 3 to form a main shaft arrangement 2. Crushing is effected between these two crushing surfaces as the material travels downward between the two crushing surfaces, being progressively crushed until it is small enough to fall out through the gap between the two crushing surfaces. The figure shows a situation where the main shaft arrangement 2 after periodic maintenance is being lowered towards an eccentric bushing 5 in the gyratory crusher. When lowered all the way down, the main shaft 3 is fixed in and supported by the eccentric bushing 5. During rotation of the eccentric bushing 5, the position of the main shaft 3 with respect to the frame 8 of the gyratory crusher 1 is changed. The rotation of the eccentric bushing 5 and thereby the main shaft arrangement 2 is produced by means of a gear mechanism comprising a drive shaft 9 with a drive wheel 10 engaged with a gear wheel 11 fixed to the eccentric bushing 5. Guiding means 7 protruding radially in relation to the centre axis of the main shaft 3 are mounted on the main shaft arrangement 2 before the main shaft arrangement 2 is lowered down. This can preferably be done when the main shaft arrangement 2 is arranged on a stationary fixture for maintenance work. The guiding means 7 must protrude sufficiently from the main shaft arrangement 2 so as to be visible when viewed from an axial top position over the main shaft arrangement 2. This means that the guiding means 7 must be designed so that they protrude radially to such an extent that a crane operator with a view from the axial top position is capable of lowering the main shaft 3 into the eccentric bushing 5 while observing the relationship between the second crushing surface 6 and the guiding means 7.

The guiding means 7 shown in the bottom view of the main shaft arrangement 2 in FIG. 2 comprises four identical substantially rectangular guide members 7a fastened on the circumference underneath the first crushing surface 4 and arranged at an angle of 90 degrees between them. Other forms, numbers or distribution or even colours of the guiding means 7 around the main shaft arrangement 2 may be used as long it is suitable for the specific gyratory crusher 1. However, the guiding means 7 must give the operator, when viewing the main shaft arrangement 2 from the above, the opportunity to observe the relationship between the second crushing surface 6 and the guiding means 7. Typically the guiding means 7 will be adjusted so there initially is a clearance between the second crushing surface 6 and the guiding means 7 so the operator can observe the clearance until the main shaft arrangement 2 is lowered to an extent where the guiding means 7 come into contact with the second crushing surface 6 and center up the main shaft arrangement 2 in relation to the concave second crushing surface 6 themselves.

In FIG. 3 is shown a radial sealing member 12 provided at a central portion of the main shaft 3, with the sealing member 12 during the lowering of the main shaft arrangement 2 being guided into a centrally positioned sleeve 13 in the gyratory crusher 1. This sealed connection prevents oil from leaving the eccentric bushing 5. A sealing guiding device comprising a release ring 14 for forcing together a number of centering members 15 arranged around the sleeve 13 is releasably attached to the sleeve. Each centering member 15 comprises an inclined portion which is located above the sleeve 13 for guiding the sealing member 12 into the sleeve 13. After the sealing member 12 is guided into the sleeve 13, the guiding means 7 fastened to the main shaft arrangement 2 will, when lowering down the main shaft arrangement, impact the release ring 14 thereby forcing it to lose its grip and fall off the centering members 15 and further down into the gyratory crusher 1. The centering members 15 are connected to the release ring 14 by means of a chain (not shown) which means that the centering members 15, being pressed against the sleeve 13 only by means of the release ring 14, will be pulled down together with the release ring 14. The release ring 14 may have a tapered portion for easy disconnection when pushed by the guiding means 7. The released sealing guiding device is removed prior to the operation of the gyratory crusher 1.

FIG. 4 shows an embodiment where the sleeve 13 has an upper part 13a which prior to lowering down the main shaft arrangement 2 is guided over the sealing member 12 on the main shaft 2. This can preferably be done when the main shaft arrangement 2 is arranged on a stationary fixture for maintenance work. A bottom part 13b of the sleeve is attached to the frame 8 in the gyratory crusher 1. When the main shaft 3 has been placed in the eccentric bushing 5, the lower free end of the upper part 13a of the sleeve and the upper free end of the bottom part 13b of the sleeve will be at the same vertical level and connected by means of screwed connections. This eliminates the need for presence of personnel underneath the main shaft 3 to guide the sealing member 12 into the sleeve 13.

1. A method for assembling a gyratory crusher (1) where a main shaft arrangement (2) having a main shaft (3) with a central axial portion enclosed by a first crushing surface (4) is lowered axially from a free-hanging position into a centrally positioned bushing (5) which provides guidance and support for the main shaft (3) where at least a portion of the bushing (5) is located below the first crushing surface (4) which is configured for interaction with an opposite second crushing surface (6); wherein the method comprises the steps of:
mounting guiding means (7) on the main shaft arrangement (2) prior to guiding the main shaft (3) into the bushing (5) where the guiding means (7) protrude radially in relation to the centre axis of the main shaft (3) to such an extent that the guiding means (7) are visible when viewed from an axial top position over the main shaft arrangement (2), and
having an operator with a view from the axial top position to lower the main shaft (3) down into the bushing (5) while observing the relationship between the second wear surface (6) and the guiding means (7).

2. The method according to claim 1, wherein the guiding means (7) are dismounted and removed after the main shaft (3) is guided into and supported by the bushing (5).

3. The method according to claim 1, wherein the radial sealing member (12) provided at a central portion of the main shaft (3) during the lowering of the main shaft arrangement (2) is guided into a centrally positioned sleeve (13) in the gyratory crusher (1) by means of a sealing guiding device which is releasably attached to the sleeve (13) and where the sealing guiding device is attached prior to lowering down the main shaft arrangement (2).

4. The method according to claim 3, wherein a portion of the main shaft (3) is guided into the bushing (5) prior to the radial sealing member (12) being guided into the sleeve (13).

5. The method according to claim 3, wherein the guiding means (7) during the lowering of the main shaft arrangement (2) and after the sealing guiding device has guided the radial sealing member (12) into the sleeve (13) impacts the sealing guiding device to release it from the sleeve (13).

16. The method according to claim 5, wherein the released sealing guiding device is removed prior to the operation of the gyratory crusher (1).

17. The method according to claim 1, wherein an upper part (13a) of a sleeve prior to lowering down the main shaft arrangement (2) is guided over a radial sealing member (12) provided on a central portion of the main shaft (3) and in that the upper part (13a) of the sleeve is connected to a bottom part of the sleeve (13b) which is attached to a frame (8) in the gyratory crusher (1) after the main shaft (3) is placed in the bushing (5).

8. The method according to claim 7, wherein the upper part (13a) and the bottom part (13b) of the sleeve are connected to each other by means of fastening means.
